(19) United States
(12) Patent Application Publication
(10) Pub. No.: US 2005/0041565 A1
(43) Pub. Date: Feb. 24, 2005

(54) Control circuit for an optical pickup head in an optical disk drive

(76) Inventors: Tse-Hsiang Hsu, Hsinchu (TW); Chih-Cheng Chen, Hsin Chu City (TW)

Correspondence Address: BIRCH STEWART KOLASCH & BIRCH, PO BOX 747, FALLS CHURCH, VA, 22040-0747, US

(21) Appl. No.: 10/921,806

(22) Filed: Aug. 20, 2004

(30) Foreign Application Priority Data
Aug. 22, 2003 (TW) 092123233
Mar. 29, 2004 (TW) 093108449

(51) Int. Cl. G11B 7/00; G11B 5/09

(52) U.S. Cl. 369/124.12; 369/47.25; 369/59.15

(57) ABSTRACT

A control circuit for an optical pickup head in an optical disk drive for outputting filtered signals. The control circuit includes a laser drive unit for receiving a laser control signal to control a laser light source to generate a laser beam with a specified power, a photo detector for receiving the laser beam reflected from an optical disk and outputting a plurality of light detection signals, and a filter unit for filtering out the high frequency components of the light detection signals and then outputs the filtered signals. Since the high frequency components have been suppressed in the filtered signals, the transmission distortion can be reduced when the filtered signals are transmitted to the optical disk drive controller through a flexible cable. Accordingly, a more stable wobble signal can be obtained by the optical disk drive controller to enhance the stability of the optical disk drive operation based on the filtered signals.

This application claims the benefit of the filing date of Taiwan Application Ser. No. 092123233, filed on Aug. 22, 2003, and Taiwan Application Ser. No. 093108449, filed on Mar. 29, 2004, the contents of which are incorporated herein by reference.

### BACKGROUND

The invention relates to a control circuit for an optical pickup head (PUH), and more particularly to a control circuit for an optical pickup head in an optical disk drive, which utilizes a filter unit comprising at least one low-pass filter each for filtering one of the light detection signals or a linear combination of the light detection signals, and generating a filtered signal. The output signals of the PUH includes the at least one filtered signal.

As the speed of the computer's microprocessor getting higher and higher, the speed of the peripheral apparatus coupled to the computer also has to be correspondingly increased in order to increase the overall performance. Taking the optical disk drive (ODD) as an example, the read/write speed thereof has been increased from the 1× to the current 50× and even more.

FIG. 1 shows the architecture diagram of a typical optical disk drive system. Referring to FIG. 1, the conventional optical disk drive system includes two main portions, one of which is an optical pickup head 11, and the other of which is an optical disk drive controller (ODD controller) 12 connected to the optical pickup head 11 by a flexible cable 13. Because the optical pickup head 11 have to be moved between the inner and outer tracks of the optical disk 14, the typical length of the flexible cable 13 of the optical disk drive is about 6-8 cm in order to cover the whole optical disk 14. The control circuit in the optical pickup head 11 includes a laser diode (LD) 111 for generating a laser beam to illuminate the optical disk 14, a laser diode drive (LDD) 112 for controlling the LD 111 to generate the laser beam with specified power, and a photo detector integrated circuit (PDIC) 113 for converting the laser beam reflected from the optical disk 14 into several light detection signals. Of course, the optical pickup head 11 also includes other parts and optical devices, such as a beam splitter 114, an objective lens 115, etc.

The LD 111 is for generating the laser beam, which passes through the beam splitter 114 and the objective lens 115 and illuminates the surface of the optical disk 14. Then, the laser beam reflected from the surface of the optical disk 14 illuminates the PDIC 113 through the objective lens 115 and the beam splitter 114. The power of the laser beam generated by the LD 111 is controlled by the LDD 112 according to a laser control signal (LCS). For example, while the optical disk drive is recording data on the disk, the laser control signal contains a series of write pulse, the output power (intensity of laser beam) of the LD is proportional to the amplitude of the write pulse. The PDIC 113 receives the reflected laser beam and generates a plurality of light detection signals.

As shown in FIG. 1 the conventional PDIC 113 includes a main light receiving element 113a and two auxiliary light receiving elements 113b and 113c. The main light receiving element 113a includes four light detection areas A, B, C and D, wherein the light detection areas A and D are positioned at the outer side while the light detection areas B and C are positioned at the inner side. The auxiliary light receiving element 113b includes two light detection areas E and H positioned at the outer side. The auxiliary light receiving element 113c includes two light detection areas G and F positioned at the inner side. The light detection areas A, B, C, D, E, F, G and H generate light detection signals S_{A}, S_{B}, S_{C}, S_{D}, S_{E}, S_{F}, S_{G}, and S_{H}, respectively. Typically, these light detection signals are delivered to the ODD controller through the flexible cable 13 so that the associated optical disk drive control operations can be performed accordingly.

Typically, the ODD controller 12 includes a radio frequency amplifier (RF amplifier) 121, a servo signal processing unit 122, a digital signal processing unit 123, and an interface and decoding unit 124. The RF amplifier 121 receives the associated signals, such as the light detection signals transmitted through the flexible cable 13, amplifies the signals and then generates the desired signals and data. During the recording operation, the ODD controller 12 has to output the laser control signal to the optical pickup head 11 so as to control the LD 111 to generate the laser beam, which is used to write the data onto the optical disk 14. When the optical disk drive is executing its recording process, the PDIC 113 also simultaneously receives the laser beam reflected from the optical disk 14 and generates the light detection signals. Therefore, based on the light detection signals, the ODD controller 12 can recover the wobble signal which is originally embedded in the optical disk and is an important signal for optical disk operation.

When the optical disk drive is executing the recording process, the LDD 112 drives the LD 111 according to the laser control signal so as to generate the laser beam. The light beam reflected from the optical disk 14 is converted into a plurality of light detection signals by the PDIC 113. Then, the light detection signals include not only the information of the wobble signal but also the information of the laser control signal. The frequency of the laser control signal is relatively high as compared to that of the wobble signal. For example, the frequency of the wobble signal for the DVD-R format is 140 KHz while the frequency of the laser control signal covers the frequency band ranging between 900 K and 4.3 MHz, so they resides at different frequency bands. As well known, due to the transmission characteristics, e.g. the slew rate and bandwidth, of the flexible cable 13, the flexible cable 13 is not suitable for delivering a high-frequency signal. It is found that when the light detection signals are transmitted to the ODD controller 12 from the optical pickup head 11 via the flexible cable 13, the high-frequency components of the light detection signals will be greatly distorted and will further interfere with the low-frequency components thereof. As a result, the information related to the wobble signal, which belongs to the low-frequency components are distorted.

Conventionally, some kinds of the optical pickup head 11 output the light detection signals S_{A}, S_{B}, S_{C}, and S_{D} to the ODD controller 12 via the flexible cable 13. But some kind of the optical pickup head further calculates a push-pull signal S_{PP}=(S_{A}+S_{D})−(S_{B}+S_{C}) according to the light detection signals S_{A}, S_{B}, S_{C}, and S_{D}, and then outputs the push-pull signal S_{PP} to the ODD controller 12 via the flexible cable 13. Due to mainly containing low-frequency components, the push-pull signal S_{PP} is more suitable for being transmitted over the flexible cable 13. In the method, however, the SNR (Signal to noise ratio) is also reduced owing to the reduced signal amplitude. That is, the immunity of the signal to noise is sacrificed, which is not advantageous to the signal transmission. So, it is not a good method for solving the influence of the flexible cable 13 due to the transmission characteristics.

Furthermore, because the write speed of the optical disk drive is getting higher and higher, the frequency of the laser control signal also increases therewith, and the wobble signal will be distorted more seriously. Thus, the optical disk drive controller may not be able to correctly and stably recover the wobble signal, and the optical disk drive may not operate normally. Hence, it is an important subject to reduce the distortion of the wobble signal.

### SUMMARY

In view of the above-mentioned problems, an object of the invention is to provide a control circuit for an optical pickup head using a filter unit to filter out the high frequency components of the light detection signals and to output filtered signals.

To achieve the above-mentioned object, the control circuit includes a laser light source for generating a laser beam to illuminate tracks of an optical disk placed in the optical disk drive, a laser drive unit for receiving a laser power control signal to control the laser light source to generate the laser beam with a power specified by the power control signal, a photo detector for receiving the laser beam reflected from the optical disk and generating a plurality of light detection signals, and a filter unit comprising at least one filter, each filter receiving an input signal, suppressing bad frequency components of the input signal, and then outputting a filtered signal, wherein the input signal of each filter is one of the light detection signals, or a linear combination of the light detection signals.

Because the optical pickup head simultaneously outputs the light detection signals and the filtered signals, and the high frequency components of the filtered signals have been filtered out, the filtered signals are free from being distorted seriously due to the limitation of the slew rate, and the optical disk drive can thereby recover the stabler wobble signal using the filtered signals.

### BRIEF DESCRIPTION OF THE DRAWINGS

FIG. 1 shows the architecture diagram of a typical optical disk drive (ODD) system.

FIG. 2 shows a block diagram of a control circuit for an optical pickup head of the present invention.

FIG. 3A shows the waveform of the light detection signal S_{A} obtained from the laser beam reflected from the optical disk and converted by the photo detector integrated circuit when the optical disk drive is performing the recording process.

FIG. 3B shows the waveform of the light detection signal S*_{A} received by the ODD controller after the light detection signal S_{A} is transmitted to the ODD controller via the flexible cable.

FIG. 3C shows the waveform of the filtered signal X_{A} obtained after the light detection signal S_{A} passes through a LPF unit at the optical pickup head according to the invention.

FIG. 3D shows the waveform of the filtered signal X*_{A} received by the optical disk drive controller after the filtered signal X_{A} is transmitted to the optical disk drive controller via the flexible cable.

FIG. 4A shows the waveform of the first added signal S_{AD} and the second added signal S_{BC}.

FIG. 4B shows the waveform of the push-pull signal S_{PP} obtained by the ODD controller according to the received first added signal S*_{AD} and the received second added signal S*_{BC} after the first added signal S_{AD} and the second added signal S_{BC} are transmitted to the ODD controller via the flexible cable.

FIG. 4C shows the waveforms of the filtered signals X_{AD} and X_{BC} generated after the first added signal S_{AD} and the second added signal S_{BC} pass through a LPF unit at the optical pickup head according to another embodiment of the invention.

FIG. 4D shows the waveform of the push-pull signal S_{PP} obtained by the optical disk drive controller according to the received filtered signals X*_{AD} and X*_{BC} after the filtered signals X_{AD} and X_{BC} are transmitted to the optical disk drive controller via the flexible cable.

FIG. 5A shows the waveform of the wobble signal recovered by the ODD controller after the push-pull signal S_{PP} obtained according to the prior art passes through a filter.

FIG. 5B shows the waveform of the wobble signal recovered by the ODD controller after the push-pull signal S_{PP} obtained according to the invention passes through a filter.

FIG. 6 shows a control circuit for an optical pickup head according to another embodiment of the present invention.

FIG. 7 shows an embodiment of a resistor capacitor network of the low-pass filter.

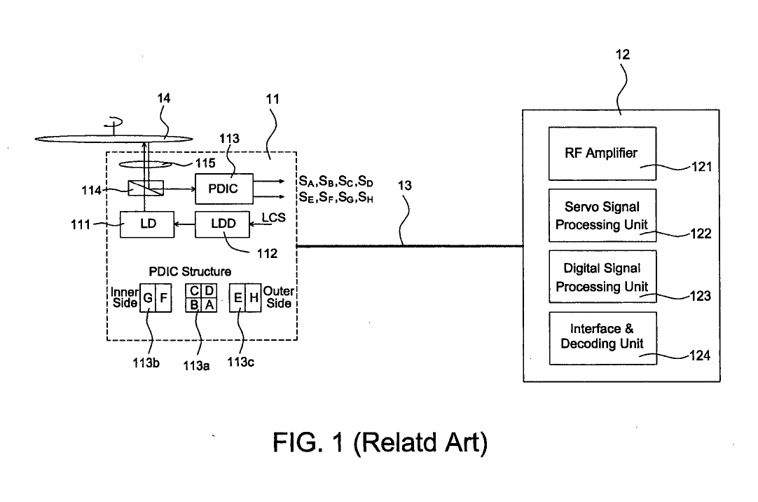

### DETAILED DESCRIPTION

The control circuit for an optical pickup head of the present invention will be described with reference to the accompanying drawings.

In the recording process, the optical pickup head of the optical disk drive generates laser beam with different intensity according to the laser control signal so as to write the data (mark) onto the optical disk. Meanwhile, the PDIC converts the reflected laser beam into a plurality of light detection signals, which will be transmitted to the optical disk drive controller via the flexible cable. The light detection signals contain not only the high frequency components corresponding to the laser control signal but also the low frequency components corresponding to a wobble signal. As the write speed of the optical disk drive getting higher and higher, due to the transmission characteristics of the flexible cable, the signal waveform of each light detection signal corresponding to the laser control signal are found to be distorted and interfere with the signal waveform corresponding to the wobble signal. Thus, the optical disk drive controller cannot recover the wobble signal correctly and stably, and the optical disk drive cannot operate normally accordingly.

In order to avoid this problem, the invention keeps the originally transmitted signals, such as the light detection signals S_{A}, S_{B}, S_{C} and S_{D}, at the side of the optical pickup head, and further utilizes a filter unit to filter out the high-frequency components of the light detection signals to generate filtered signals. The filtered signals are then transmitted to the optical disk drive controller via the flexible cable. From the viewpoint of the frequency spectrum, the laser control signal contains rapid signal level transition and thus will mainly compose of the high-frequency components. These high frequency components will be greatly suppressed after passing through the low-pass filter. Therefore, the filtered signals would be more suitable for being transmitted over the flexible cable, and the low frequency components corresponding to the wobble signal would be well reserved to the optical disk drive controller without significant distortion. That is, the filtered signals received by the optical disk drive controller are free from being seriously distorted owing to the flexible cable. This is very important to a high-speed CD recording control. In addition, because the light detection signals are still needed for other servo mechanisms, the optical pickup head has to output the filtered signals as well as the light detection signals to the optical disk drive controller via the flexible cable.

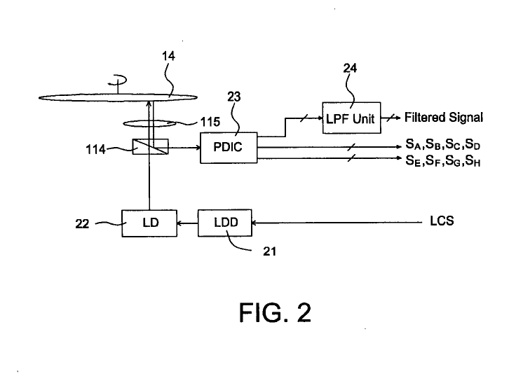

FIG. 2 shows a block diagram of a control circuit for an optical pickup head of the present invention. Referring to FIG. 2, the control circuit for an optical pickup head of the present invention includes a laser diode drive (LDD) 21, a laser diode (LD) 22, a photo detector integrated circuit (PDIC) 23, and a low-pass filter (LPF) unit 24. The LDD 21 receives a laser control signal (LCS) and controls the LD 22 to generate a laser beam with a power specified by the LCS. The laser beam passes through the beam splitter 114 and the objective lens 115 and impinges on the optical disk 14. If the laser beam is of a power high enough, a mark will be formed in the track of the optical disk 14. On the other hand, if the laser beam is of a low power, the optical disk 14 is kept unchanged. In both cases, the laser beam is reflected from the optical disk 14 to the PDIC 23. The PDIC 23 utilizes the light detecting elements to receive the laser beam and convert it into a plurality of light detection signals. For example, the typical main light detection signals include light detection signals S_{A}, S_{B}, S_{C}, and S_{D}, and the auxiliary light detection signals include the light detection signals S_{E}, S_{F}, S_{G} and S_{H}. In addition, the LPF unit 24 can be disposed in the PDIC 23.

In the typical wobble signal recovery process, one of the major input signals is the push-pull signal S_{PP}, which is obtained by linearly combining the light detection signals S_{A}, S_{B}, S_{C} and S_{D}, and is obtained by S_{PP}=(S_{A}+S_{D})−(S_{B}+S_{C}). Once the ODD controller 12 obtains the push-pull signal S_{PP}, the wobble signal can thus be estimated accordingly. Typically, the way for obtaining the push-pull signal S_{PP} includes the following scenarios:
(1) The optical pickup head 11 directly outputs the four light detection signals S_{A}, S_{B}, S_{C} and S_{D} to the ODD controller 12 via the flexible cable 13, and the four light detection signals received by the ODD controller 12 are denoted as S*_{A}, S*_{B}, S*_{C}, and S*_{D}, respectively. Then, the ODD controller 12 calculates (S*_{A}+S*_{D})−(S*_{B}+S*_{C}) to obtain the push-pull signal S_{PP}.
(2) The optical pickup head 11 adds the light detection signals S_{A} to S_{D} to generate a first added signal S_{AD}, and adds the light detection signals S_{B} to S_{C} to generate a second added signal S_{BC}. In other words, S_{AD}=S_{A}+S_{D}, and S_{BC}=S_{B}+S_{C}. Then, the two added signals S_{AD} and S_{BC} are output to the ODD controller 12 via the flexible cable 13. The two added signals received by the ODD controller 12 are denoted as S*_{AD}, S*_{BC}, and ODD controller 12 calculates S*_{AD}−S*_{BC} to obtain the push-pull signal S_{PP}.
(3) The optical pickup head 11 directly calculates the push-pull signal S_{PP}=(S_{A}+S_{D})−(S_{B}+S_{C}), and then outputs the push-pull signal S_{PP} to the ODD controller 12 via the flexible cable 13. The ODD controller 12 thus obtains the push-pull signal S_{PP}. However, the magnitude of the push-pull signal S_{PP} is typically much smaller than that of the added signal S_{AD} or S_{BC}, such that the noise-resistant ability of the push-pull signal S_{PP} is much weaker than that of the added signal S_{AD} or S_{BC} during the transmission over the flexible cable 13. Thus, the first and second scenarios are often used to obtain the push-pull signal S_{PP}.

From the above description, for a conventional optical pickup head, the output signals to the optical disk drive controller via the flexible cable are the light detection signals S_{A}, S_{B}, S_{C}, and S_{D}, and, if necessary, the added signals S_{AD} and S_{BC}. However, during the recording process of the optical disk drive, these signals outputted from the optical pickup head contain high frequency components corresponding to the LCS, and are found to be seriously distorted due to the transmission characteristics of the flexible cable 13. The control circuit of the present invention utilizes the LPF unit 24 to filter out the high frequency components of these signals, either the light detection signals or the linear combination of the light detection signals, outputted from the PDIC 23, and then to generate the filtered signals with the high frequency components suppressed. It is the filtered signals to be output to the optical disk drive controller via the flexible cable. Because the high frequency components of each filtered signal have been greatly suppressed, the distortion of such a filtered signal due to the transmission characteristics of the flexible cable is also greatly reduced. Thus, the optical disk drive controller can recover the clock of the wobble signal more correctly and stably according to the filtered signals, and the recovered clock can be utilized to control the operation of the optical disk drive. Notably, how to recover the wobble signal is not a concerned subject of the invention, and detailed descriptions thereof will be omitted.

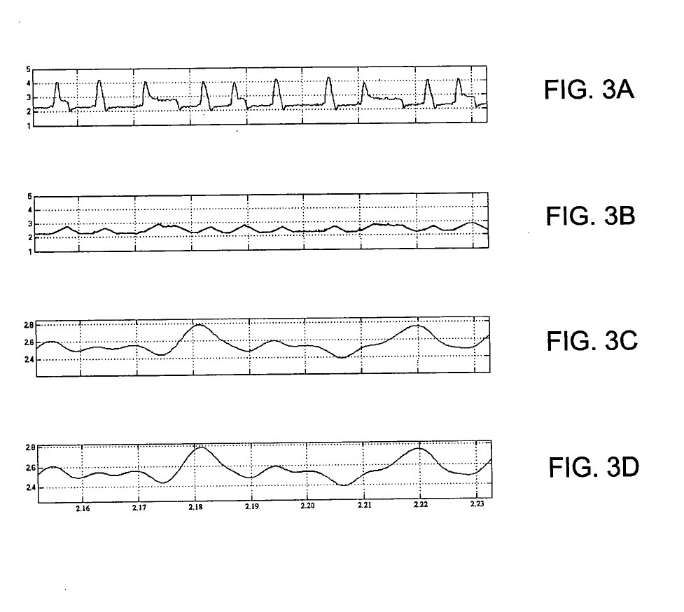

FIG. 3A shows the waveform of the light detection signal S_{A} outputted by the PDIC based on the laser beam reflected from the optical disk when the drive is performing the recording process. Because the optical disk is in the recording process, the laser power will be adjusted with the data to be recorded on the optical disk.

FIG. 3B shows the waveform of the light detection signal S*_{A} received by the ODD controller 12 after the light detection signal S_{A} is transmitted to the ODD controller 12 via the flexible cable 13. The LCS contains high frequency components, the light detection signal S_{A} in the recording process will also contain high frequency components, which will be distorted by the flexible cable 13 and further interfere with the wobble signal information carried by the light detection signal. Comparing FIGS. 3B with 3A, it is found that the waveform of the light detection signal S*_{A} is seriously distorted, which is due to the transmission over the flexible cable 13.

FIG. 3C shows the waveform of the filtered signal X_{A} obtained by feeding the light detection signal S_{A} to a LPF unit in the optical pickup head 11 according to the invention. Because the LPF unit is used to suppress the high frequency components of the input signal, the waveform of the filtered signal X_{A} becomes much smoother.

FIG. 3D shows the waveform of the filtered signal X*_{A} received by the optical disk drive controller after the filtered signal X_{A} is transmitted to the optical disk drive controller via the flexible cable. Because the waveform of the light detection signal becomes much smoother after passing through the filter unit, it will suffer less distortion caused by the flexible cable 13, and the filtered signal X*_{A} received by the ODD controller 12 is only slightly distorted as can be seen by comparing FIG. 3C and FIG. 3D.

In FIGS. 3A to 3D, the light detection signal S_{A} is illustrated as an example, and other light detection signals S_{B} to S_{D}, or added signals S_{AD} and S_{BC} will have the same scenarios. Thus, detail descriptions thereof will be omitted.

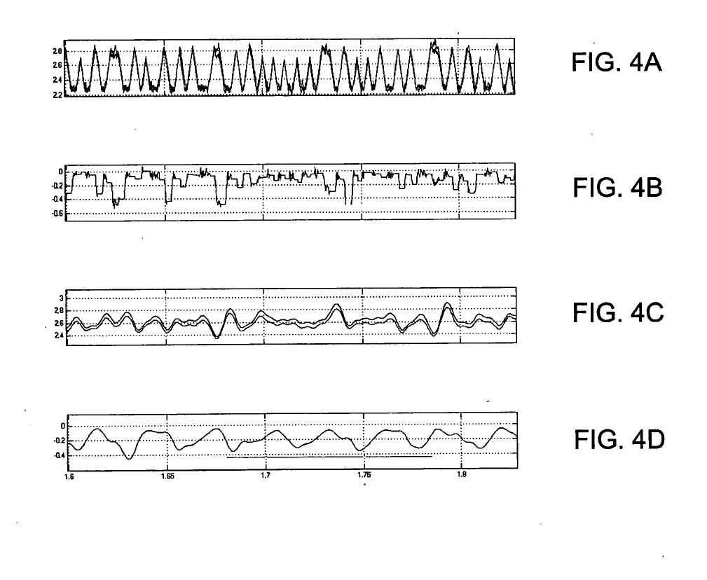

FIGS. 4A to 4D show associated signal waveforms and reference waveforms according to another embodiment of the invention. FIG. 4A shows the waveform of the first added signal S_{AD} and the second added signal S_{BC}. FIG. 4B shows the waveform of the push-pull signal S_{PP} obtained by the ODD controller 12 according to the received first added signal S*_{AD} and the received second added signal S*_{BC} after the first added signal S_{AD} and the second added signal S_{BC} are transmitted to the ODD controller 12 via the flexible cable 13. FIG. 4C shows the waveforms of the filtered signals X_{AD} and X_{BC} generated after the first added signal S_{AD} and the second added signal S_{BC} pass through the LPF unit 24 at the optical pickup head 11 according to another embodiment of the invention. FIG. 4D shows the waveform of the push-pull signal S_{PP} obtained by the ODD controller 12 according to the received filtered signals X*_{AD} and X*_{BC} after the filtered signals X_{AD} and X_{BC} are transmitted to the ODD controller 12 via the flexible cable.

As shown in FIG. 4B, owing to the influence of the transmission characteristics of the flexible cable 13, the waveform of the push-pull signal S_{PP} obtained by the ODD controller 12 according to the received first added signal S*_{AD} and the second added signal S*_{BC} is seriously distorted. So, it would be not easy to recover and get a good quality wobble signal. As shown in FIG. 4D, however, because the first added signal S_{AD} and the second added signal S_{BC} are processed by the LPF unit 24 before being transmitted through the flexible cable 13, the high frequency components thereof are suppressed. Thus, the received filtered signal X*_{AD} and X*_{BC} received by the ODD controller 12 would not be seriously distorted. Consequently, the waveform of the push-pull signal S_{PP} obtained according to the received filtered signals X*_{AD} and X*_{BC} is free from being seriously distorted, as shown in FIG. 4D. From the performance improvement shown between the FIG. 4D and FIG. 4B, by low-pass filtering the signals at the optical pickup head side before being transmitted by the flexible cable 13, the signal distortion problem caused by the flexible cable 13 may be effectively mitigated.

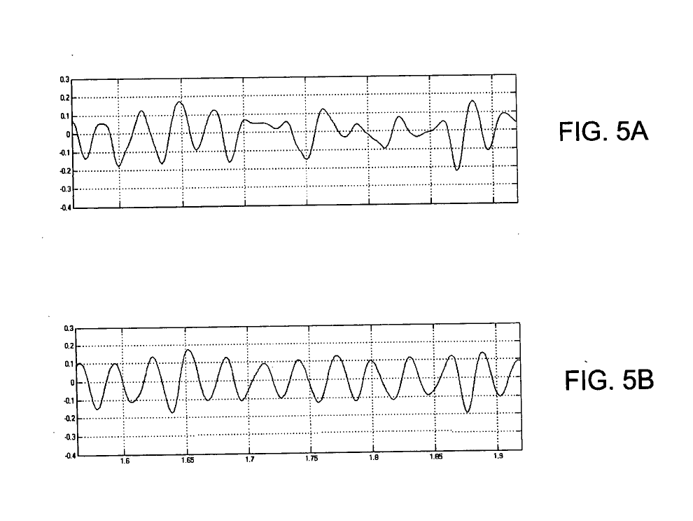

FIG. 5A shows the waveform of the filtered wobble signal recovered by the ODD controller after the push-pull signal S_{PP} obtained according to the prior art, and FIG. 5B shows the waveform of the filtered wobble signal recovered by the ODD controller after the push-pull signal S_{PP} obtained according to the present invention. As shown in FIG. 5A, the waveform of the filtered wobble signal generated according to the prior art is distorted, the reference clock generated using a phase locked loop (PLL) according to the filtered wobble signal would have large jitters and would be unstable. As shown in FIG 5B, the filtered wobble signal generated according to the invention is quite smooth, so the reference clock generated using the PLL according to the filtered wobble signal would be stabler. The stable reference clock is quite important with respect to the write control stability of the optical disk drive.

In addition, the practical optical disk drive typically have more than one kind of write speed and is capable of choosing an suitable write speed for the optical disk depending on the optical disk currently used. So, in order to match with different write speed, the 3 dB bandwidth of the LPF unit 24 has to be correspondingly adjusted according to the write speed.

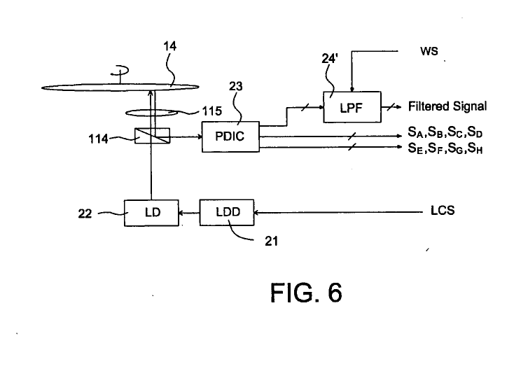

FIG. 6 shows a control circuit for an optical pickup head according to another embodiment of the invention. This embodiment is similar to that of FIG. 2, and their differences are described in the following. As shown in FIGS. 2 and 6, the difference therebetween is that the filter bandwidth of the LPF unit 24′ of the optical pickup head is controlled according to a write speed signal WS. The write speed signal WS may be used to identify the current write speed, such as 1×, 2×, 4×, 8×, or the like. So, the LPF unit 24′ can change its bandwidth according to the write speed signal WS. For example, in the write speed 1×, the write speed signal WS is set to be 1, and the frequency of the wobble signal is typically 817.5K, and the 3 dB bandwidth of the LPF unit 24′ is set to be around 1200K. In the write speed 4 ×, the write speed signal WS is set to be 4, and the frequency of the wobble signal is typically 3.27M, and the 3 dB bandwidth of the LPF unit 24′ can be set to be around 4.6M.

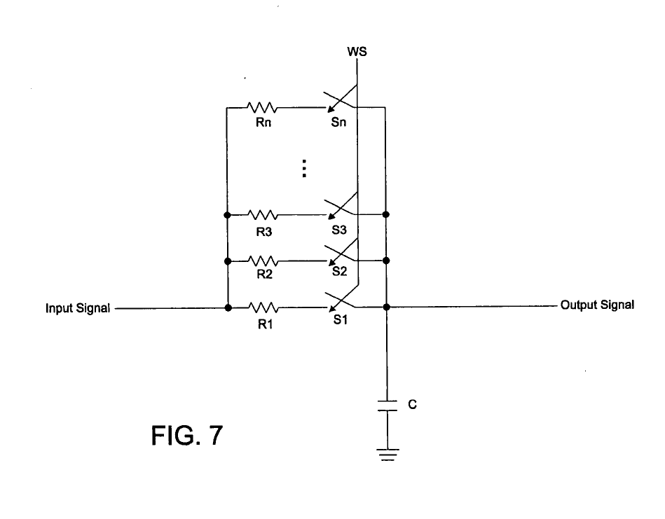

FIG. 7 shows an embodiment of a resistor capacitor (RC) network of the low-pass filter. As shown in FIG. 7, each low-pass filter in the LPF unit 24′ includes a plurality of resistors R1 to Rn, a capacitor C, and a plurality of switches S1 to Sn. The switches S1 and Sn are controlled by the write speed signal WS so as to adjust the resistance of the RC network. In a result, the bandwidth of the low-pass filter is adjusted via different combinations of resistors controlled by the write speed signal WS.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

1. A control circuit for an optical pickup head in an optical disk drive, the optical pickup head having a laser light source for generating a laser beam to illuminate tracks of an optical disk placed in the optical disk drive, the control circuit comprising:
a laser drive unit for receiving a laser control signal so as to control the laser light source to generate the laser beam with a power specified by the laser control signal;
a photo detector for receiving a reflected laser beam from the optical disk, and for outputting a plurality of light detection signals according to the reflected laser beam; and
a filter unit having at least one filter, each filter receiving an input signal, suppressing bad components of the input signal, and then outputting a filtered signal, wherein the input signal of each filter is one of the light detection signals, or a linear combination of the light detection signals.

2. The control circuit according to claim 1, wherein each filter in the filter unit is a low-pass filter.

3. The control circuit according to claim 2, wherein the filter unit further receives a speed control signal to set a bandwidth of each filter in the filter unit.

4. The control circuit according to claim 1, wherein the output signals of the optical pickup head includes the at least one filtered signal.

5. The control circuit according to claim 1, wherein the photo detector comprises four light detecting units A, B, C and D.

6. The control circuit according to claim 5, wherein:
the light detecting units A and D are for receiving reflected laser beam from one side of the track;
the light detecting units B and C are for receiving reflected laser beam from the other side of the track; and
the light detecting units A, B, C and D output light detection signals S_{A}, S_{B}, S_{C} and S_{D}, respectively.

7. The control circuit according to claim 6, wherein the filter unit comprises four low-pass filters for respectively filtering the light detection signals S_{A}, S_{B}, S_{C} and S_{D}.

8. The control circuit according to claim 6, wherein:
the photo detector further outputs a first added signal and a second added signal;
the first added signal is the sum of the light detection signals S_{A} and S_{D}; and
the second added signal is the sum of the light detection signals S_{B} and S_{C}.

9. The control circuit according to claim 8, wherein the filter unit comprises two low-pass filters for filtering the first added signal and the second added signal, respectively.

10. The control circuit according to claim 6, further comprising two adders for adding the light detection signals S_{A} to S_{D} to output a first added signal and for adding the light detection signals S_{B} to S_{C} to output a second added signal.

11. The control circuit according to claim 10, wherein the filter unit comprises two low-pass filters for filtering the first added signal and the second added signal, respectively.
